(19) United States
(12) Patent Application Publication
(10) Pub. No.: US 2002/0178910 A1
(43) Pub. Date: Dec. 5, 2002

(54) Bottom covering of a cooling chamber for pistons of internal combustion engines

(76) Inventors: Klaus Keller, Lorch (DE); Peter Kemnitz, Leutenbach (DE); Roland Lochmann, Marbach (DE)

Correspondence Address: WILLIAM COLLARD, COLLARD & ROE, P.C., 1077 NORTHERN BOULEVARD, ROSLYN, NY, 11576, US

(21) Appl. No.: 10/149,800

(22) PCT Filed: Dec. 5, 2000
(86) PCT No.: PCT/DE00/04358

(30) Foreign Application Priority Data
Dec. 17, 1999 (DE) 199609136

(51) Int. Cl. F16J 1/04

(52) U.S. Cl. 92/208

(57) ABSTRACT

The aim of the invention is to provide an easy fastening of a tubular supply or a vertical pipe in a bottom covering of a cooling chamber for pistons of internal combustion engines, e.g. in a circular covering of a cooling channel of an articulated-skirt piston. To this end, the vertical tube or the tubular supply is clipped into the bottom covering or is fastened thereto by a detent connection.

The invention relates to a bottom covering of a cooling chamber for pistons of internal combustion engines as defined in the introductory part of claim 1.

Such coverings are known, for example from U.S. Pat. No. 4,377,967 A or DD-PS 91162. FIGS. 4 and 5 of U.S. Pat. No. 4,377,967 show a vertical tube 38 that is expected to assure a defined filling level above the covering or in the pan 70. The vertical tube is made of metal and is connected with the covering by soldering or welding. In DE-PS 91162, a small injection tube 15 projects both upwards into the cooling channel, and as a tubular feed line downwards in the direction of an oil injector nozzle 17. The type of fastening of the small injection tube on the cooling channel is not visible. It has to be assumed that the small injection tube is connected with the sheet metal cooling channel 13 by welding or soldering as well.

However, welding or soldering a rising tube or feed line to the covering represents a manufacturing step requiring substantial expenditure.

Therefore, the invention deals with the problem of securing a vertical tube or inlet line in a simple manner on a bottom covering of a cooling chamber of a piston. This problem is solved with the help of the characterizing feature of claim 1. Advantageous further developments are the objects of the dependent claims.

Locking or clipping a vertical tube or tubular inlet line into the covering provides a very simple and cost-saving type of fastening.

The component to be clipped in is advantageously made of plastic because if plastic is used, the elastically locking components can be molded on at the same time the vertical tube is produced. Plastic injection molding is a useful manufacturing process. For higher stresses, the component to be clipped in can be made of metal as well.

Vertical tubes that have to be clipped in advantageously have a cross section deviating from the circular shape, in particular an oval shape.

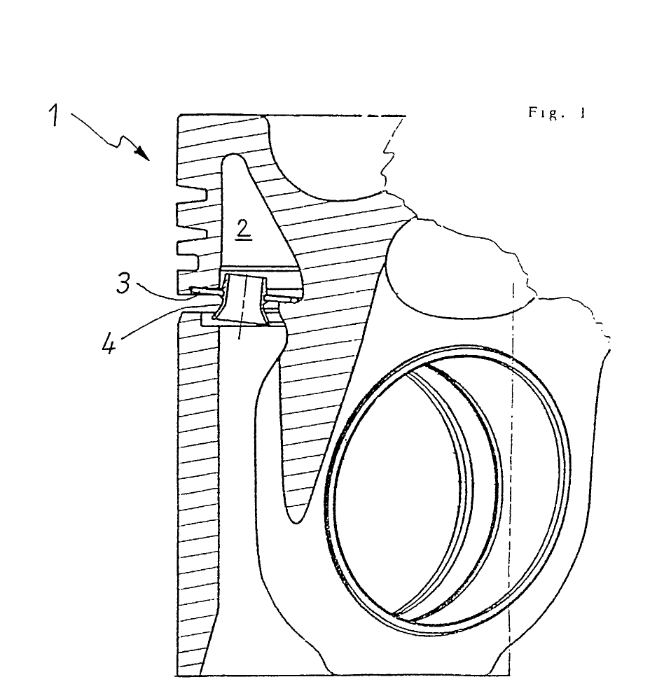

The application is especially intended for approximately circular bottom coverings of cooling channels, which, according to DE 4208037 C, are formed by a radially fixed, tensioned cup spring that is divided on its circumference in at least two parts. This cup spring freely rests radially on supports on the inside and outside on axially opposed sides, as shown in the following in FIG. 1.

However, the bottom covering of the cooling chamber may be present also in the form of one piece with the basic body of the piston, for example in connection with welded pistons, in particular in connection with pistons produced by friction welding.

The invention is explained in greater detail in the following with the help of a drawing, in which:

FIG. 1 shows a lower covering of a cooling chamber in a piston as defined by the invention; and

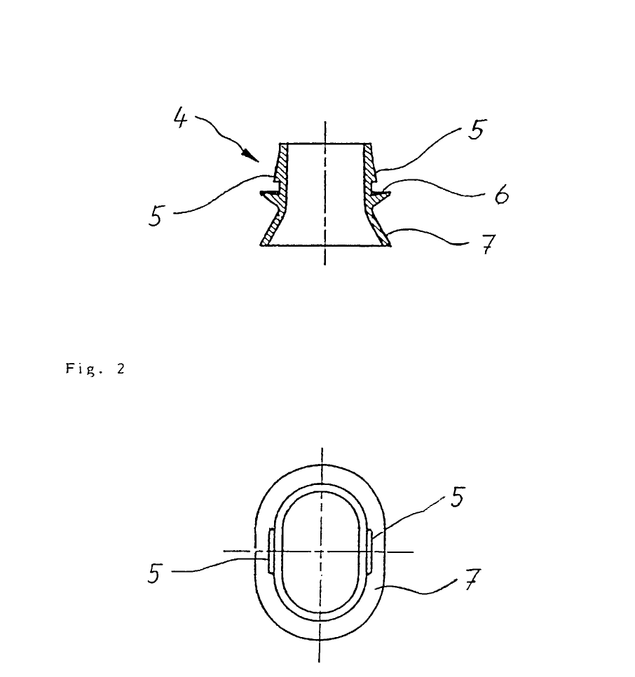

FIG. 2 shows a cooling chamber covering that can be clipped into a vertical tube (sectional view; top view).

An articulated-skirt piston 1 has a cooling channel 2 that is closed downwards by a covering 3 in the form of a cup spring that is divided in two parts. A vertical tube 4 that is designed to serve also as a tubular inlet line, is fixed in the covering 3 by being locked into the latter.

When mounted, the vertical tube 4 is pushed into the covering 3 from the bottom. When the tube is inserted, the area comprising the locking noses 5 is elastically deformed inwards, and, as soon as the contact surface 6 abuts the covering 3, elastically moves into the locking position in that the vertical tube 4 engages with the groove the covering 3, said groove being disposed directly underneath the locking noses 5. In its lower area, the vertical tube is widened in the form of a funnel.

1. A bottom covering of a cooling chamber for pistons of internal combustion engines, in particular an approximately circular covering, with a tubular inlet line and/or vertical tube each being fastened on the covering, characterized in that the tubular inlet line and/or the vertical tube are secured on the covering by a detent connection or by clipping into the covering.

2. The bottom covering of a cooling chamber for pistons according to claim 1, characterized in that the tubular inlet line or vertical tube are made of plastic.

3. The bottom covering of a cooling chamber for pistons according to claim 1 or 2, characterized in that the cross section of the tubular feed line or vertical tube deviates from the circular shape.

4. The bottom covering of a cooling chamber for pistons according to claim 3, characterized in that the cross section is oval.
